(19) United States
(12) Patent Application Publication
(10) Pub. No.: US 2012/0119539 A1
(43) Pub. Date: May 17, 2012

(54) MOTOR HOME BED

(75) Inventor: Thomas Siegert, Rheda-Wiedenbrueck (DE)

(73) Assignee: MOBIL INVEST GMBH, Hannover (DE)

(21) Appl. No.: 13/295,272

(22) Filed: Nov. 14, 2011

(30) Foreign Application Priority Data
Nov. 12, 2010 (DE) 20 2010 015 315

(51) Int. Cl. B60P 3/34

(52) U.S. Cl. 296/174

(57) ABSTRACT

A motor home bed is composed of a plurality of lying surface sections which extend transversely to the longitudinal direction of a vehicle. Of which at least one lying surface section can be pivoted into a vertical position by use of functional fittings. The bed significantly improves the variability of the useful interior of a motor home, this being achieved in that the functional fittings are mounted so as to be displaceable parallel to one another on longitudinal guides extending horizontally in the longitudinal direction of the vehicle.

### CROSS-REFERENCE TO RELATED APPLICATION

This application claims the priority, under 35 U.S.C. §119, of German application DE 20 2010 015 315, filed Nov. 12, 2010; the prior application is herewith incorporated by reference in its entirety.

### BACKGROUND OF THE INVENTION

### Field of the Invention

The invention relates to a motor home bed composed of a plurality of lying surface sections which extend transversely to the longitudinal direction of a vehicle, of which at least one lying surface section can be pivoted into a vertical position by use of functional fittings.

Published, European patent application EP 1 829 742 A2 discloses a folding bed, in particular for motor homes, which contains a lying surface extending transversely to the longitudinal direction of the vehicle but which can be pivoted up along an axis extending in the longitudinal direction of the vehicle such that at least a small gain in space is possible in the region of the living space.

### SUMMARY OF THE INVENTION

It is accordingly an object of the invention to provide a motor home bed which overcomes the above-mentioned disadvantages of the prior art devices of this general type, which substantially improves the variability of the useful interior of a motor home.

With the foregoing and other objects in view there is provided, in accordance with the invention a motor home bed. The motor home bed contains longitudinal guides extending horizontally in a longitudinal direction of a vehicle,

functional fittings mounted so as to be displaceable parallel to one another on the longitudinal guides, and a plurality of lying surface sections extending transversely to the longitudinal direction of the vehicle. At least one of the lying surface sections can be pivoted into a vertical position by the functional fittings.

According to the invention, the object is achieved, particularly in that the functional fittings are mounted so as to be displaceable parallel to one another on longitudinal guides extending horizontally in the longitudinal direction of a vehicle. As a result, it becomes possible for the motor home bed, when it is in a functional state where a lying surface section is pivoted into a vertical position, to be able to be displaced in the longitudinal direction of the vehicle such that the degree of variability over the known folding bed is already considerably increased.

According to a particularly preferred embodiment of the inventive motor home bed, it is divided at least into a rear and a front lying surface section, and the rear lying surface section is configured such that it can be pivoted into a vertical position by use of the functional fittings, in which case the front lying surface section continues to remain supported by the functional fittings such that it can be loaded, in such a way that it can continue to be used as a lying surface or as a storage surface for suitcases or other heavy objects. The three-dimensional volume exposed by the rear lying surface section can then be used as an additionally gained storage space, for instance for carrying a number of mountain bikes.

However, the motor home bed according to the invention can preferably also be displaced rearwardly along the longitudinal guide in this position with the lying surface section raised at the rear and latched in this rearward position, with the result that the useful living space within a motor home can be increased in front of the motor home bed instead of behind, and furthermore storage spaces previously covered by the front lying surface section are now made accessible from above.

In another advantageous embodiment of the subject matter of the invention with at least one rear and one front lying surface section, only the front lying surface section can also be configured such that it can be pivoted into a vertical position by use of the functional fittings, with it also being the case here that the remaining, now rear lying surface section continues to be supported by the functional fittings such that it remains useful as a narrow lying surface. This advantageous embodiment allows a gain in living space in front of a motor home bed without having to displace the latter, although, in a preferred embodiment, the entire motor home bed can again be displaced forwardly in this position along the longitudinal guides if the storage space accessible from the tailgate is to be increased.

According to a particularly advantageous embodiment of the subject matter of the invention with at least one rear and one front lying surface section, the functional fittings can be configured such that the rear and the front lying surface sections can be pivoted selectively or simultaneously into a vertical position and the motor home bed in this position can likewise selectively be displaced forwardly or rearwardly and latched in this forward or rearward position. Of course, such an embodiment offers the greatest possible gain in flexibility with regard to the configuration of a motor home interior space, be this the living space and/or the storage space.

In this arrangement, the functional fittings for each side of a lying surface section contain two double-jointed levers which are each arranged with one joint on a fitting component fixed to the longitudinal guide and on a fitting component fixed to the lying surface section, these levers producing a kinematic motion which, during a pivoting movement, prevents mutual deformation of mattresses arranged closely adjacent to one another on the lying surface sections.

Furthermore, it is advantageous for energy accumulators, in the form of mechanical springs or gas pressure dampers, to be articulated on the functional fittings and by which the weight forces of the components involved can be at least partially compensated for, with the result that it is also possible for the conversion of a motor home interior space to be performed by weaker people.

Other features which are considered as characteristic for the invention are set forth in the appended claims.

Although the invention is illustrated and described herein as embodied in a motor home bed, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, perspective view of a motor home rear bed;

FIG. 2 is a diagrammatic, perspective view of the motor home bed according to FIG. 1 with a rear raised lying surface section;

FIG. 3 is a diagrammatic, perspective view according to FIG. 2 with rearwardly displaced lying surface sections;

FIG. 4 is a diagrammatic, top plan view of the motor home bed according to FIG. 1;

FIG. 5 is a diagrammatic, top plan view of the motor home bed according to FIG. 2 from above;

FIG. 6 is a diagrammatic, top plan view of the motor home bed according to FIG. 3 from above;

FIG. 7 is a diagrammatic, lateral partial view of a functional fitting with the lying surface sections in a horizontal position;

FIG. 8 is a diagrammatic, lateral view of a functional fitting with two oppositely raised lying surface sections; and

FIG. 9 is a diagrammatic, side view of the functional fitting according to FIG. 8 with the two lying surface sections in a vertically pivoted position.

### DETAILED DESCRIPTION OF THE INVENTION

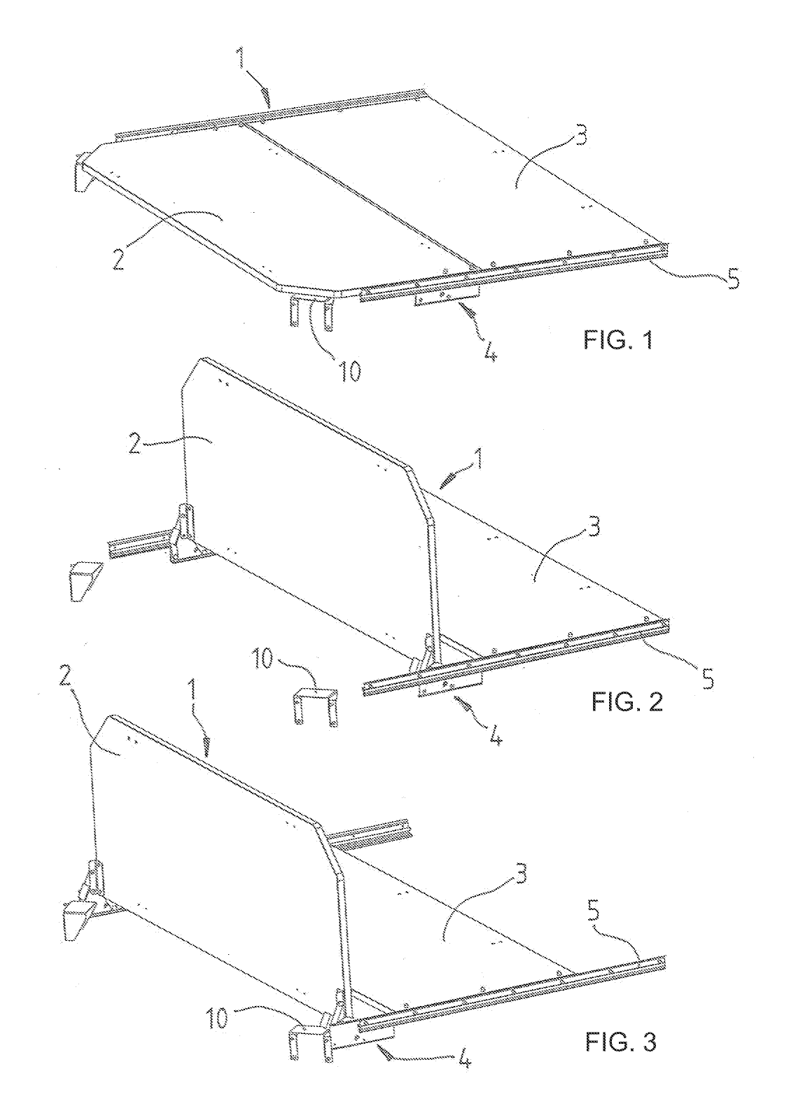

Referring now to the figures of the drawing in detail and first, particularly, to FIG. 1 thereof, there is shown a motor home bed 1 that contains a rear lying surface section 2 and a front lying surface section 3 which are arranged in the rear region of a vehicle. The two lying surface sections 2, 3 are connected to one another by functional fittings 4 which are displaceable along a longitudinal guide 5 in a direction of travel of a vehicle.

As is illustrated in FIGS. 2 and 5, the rear lying surface section 2 can be pivoted vertically upward and, as shown in FIGS. 3 and 6, the entire motor home bed 1 can then be moved rearwardly against the direction of travel, with it being possible for the front, still horizontal lying surface section 3 to continue to be used as a bed if the lying surface sections 2, 3 extend over the entire width of a vehicle and thus have the required length.

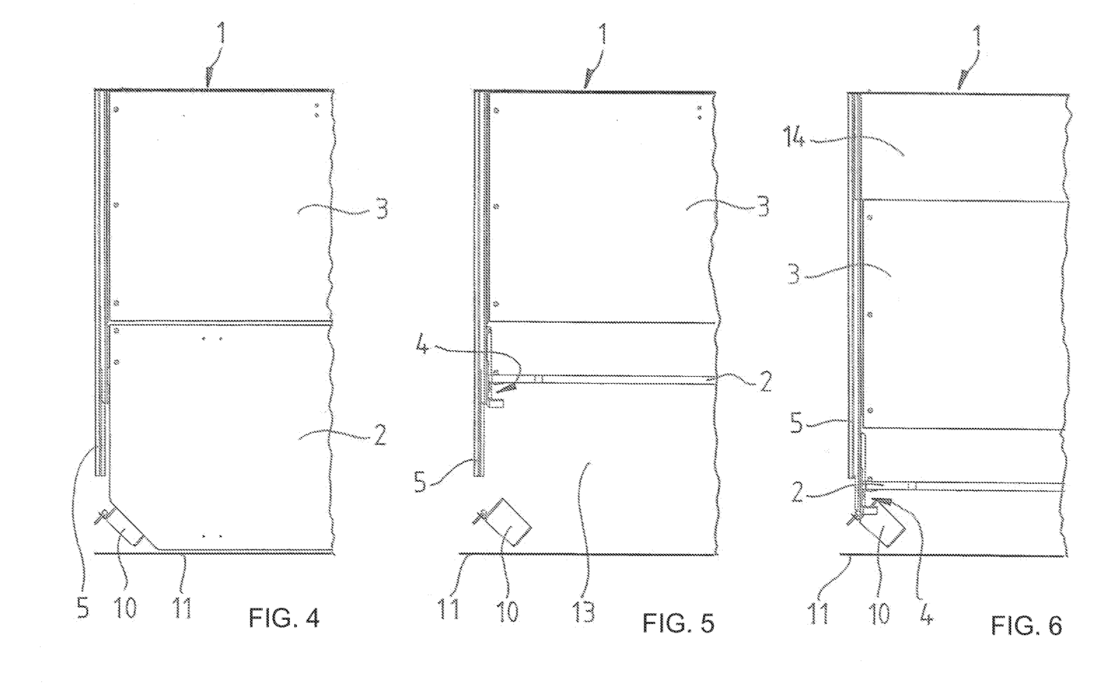

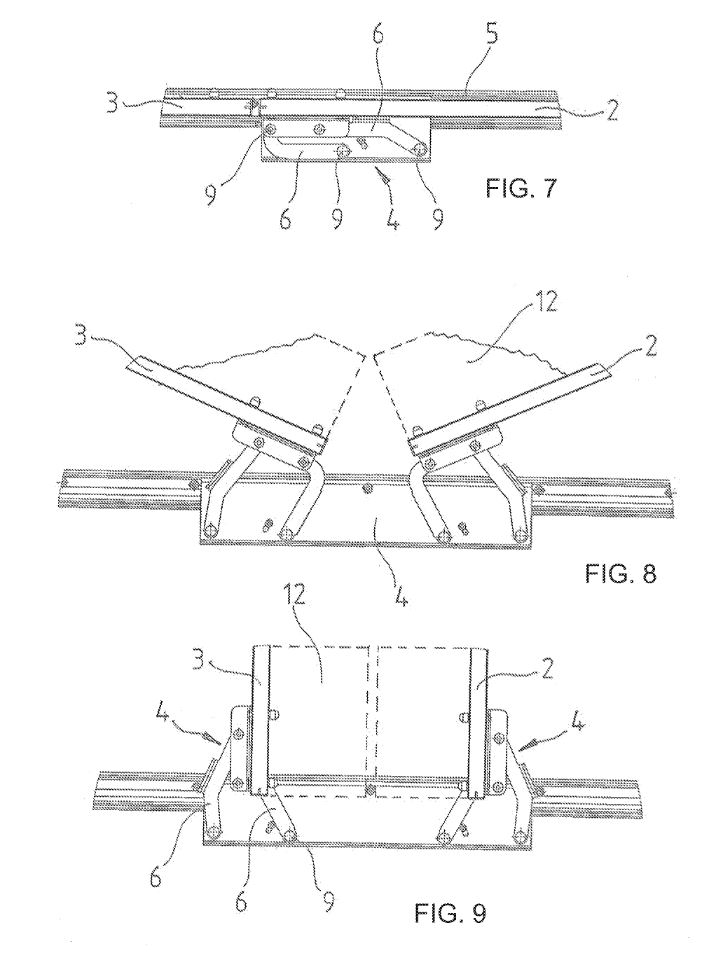

As can be seen from FIG. 4, the motor home bed 1 extends in the use position as far as the tailgate interior trim 11 so that, with the rear lying surface section 2 in the vertically swung-up state, as is illustrated in FIG. 5, a large additional storage space 13 from the floor to the roof of a motor home is produced between the tailgate interior trim 11 and the raised rear lying surface section 2. By displacing the entire motor home bed 1 rearwardly in the direction of the tailgate interior trim 11, it is possible to considerably increase a living space 14 available in the motor home in front of the motor home bed 11.

As illustrated in FIGS. 8 and 9, the functional fittings 4 can also be configured in such a way that the two lying surface sections 2, 3 can be swung up vertically with respect to one another, after which a longitudinal displacement along the longitudinal guides 5 can selectively take place toward the rear or the front.

A functional fitting 4 for one side of a lying surface section 2, 3 contains two double-jointed levers 6 which are each arranged with one joint 9 on a fitting component 7 fixed to the longitudinal guide and on a fitting component 8 fixed to the lying surface section and which, during a pivoting operation, produce a kinematic motion which prevents mutual deformation of mattresses 12 arranged closely adjacent to one another on the lying surface sections 2, 3. An energy accumulator, which is not shown in the drawing, can additionally be articulated on the functional fitting 4, this accumulator at least partially compensating for the weight forces of the components involved.

Associated with the functional fitting 4 are yet further supports 10 which are arranged in the rear region of the vehicle and on which the rear lying surface section 2 rests in the horizontally lowered state.

1. A motor home bed, containing:
longitudinal guides extending horizontally in a longitudinal direction of a vehicle;
functional fittings mounted so as to be displaceable parallel to one another on said longitudinal guides; and
a plurality of lying surface sections extending transversely to the longitudinal direction of the vehicle, at least one of said lying surface sections can be pivoted into a vertical position by means of said functional fittings.

2. The motor home bed according to claim 1, wherein said lying surface sections include a rear lying surface section and a front lying surface section, said rear lying surface section configured such that said rear lying surface section can be pivoted into the vertical position by means of said functional fittings, and said front lying surface section is supported by said functional fittings such that said front lying surface section can continue to be loaded and can be used as a lying surface.

3. The motor home bed according to claim 2, wherein the motor home bed is configured such that, with said rear lying surface section being in the vertical position, and while maintaining its use, the motor home bed can be displaced rearwardly in the vehicle along said longitudinal guides and can be latched in a rearward position.

4. The motor home bed according to claim 3, wherein in the rearward position, at least one of storage spaces previously covered by said front lying surface section are made accessible from above or a living space volume in the vehicle being a motor home is available for a movement of a user is increased.

5. The motor home bed according to claim 1, wherein said lying surface sections are divided at least into a rear lying surface section and a front lying surface section, and said front lying surface section is configured such that said front lying surface section can be pivoted into a vertical position by means of said functional fittings, and said rear lying surface section is supported by said functional fittings such that said rear lying surface section can continue to be loaded and can be used as a lying surface.

6. The motor home bed according to claim 5, wherein the motor home bed is configured such that, with said front lying surface section being in the vertical position, and while maintaining its use, the motor home bed can be displaced forward along said longitudinal guides and can be latched in a forward position.

7. The motor home bed according to claim 6, wherein a three-dimensional volume previously barred to a rear is opened up as an additional storage space.

8. The motor home bed according to claim 1, wherein said lying surface sections are divided at least into a rear lying surface section and a front lying surface section, said rear and said front lying surface sections are configured such that said lying surface sections can be pivoted into vertical positions by means of said functional fittings, and in that said lying surface sections are configured such that, in this position, said lying surface sections can be displaced rearwardly or forwardly along said longitudinal guides and can be latched in a rearward position or a forward position.

9. The motor home bed according to claim 1, wherein:
said longitudinal guides having a first fitting component;
at least one of lying surface sections having a second fitting component; and
one of said functional fittings for one side of one of said lying surface sections contains two double-jointed levers each having a joint on said first fitting component fixed to said longitudinal guide and on said second fitting component fixed to said one lying surface section and which, during a pivoting movement, have a kinematic motion which prevents mutual deformation of mattresses arranged closely adjacent to one another on said lying surface sections.

10. The motor home bed according to claim 1, wherein at least one of said functional fittings has articulated an energy accumulator which at least partially compensates for weight forces of components of the motor home bed.
